(19) United States
(12) Patent Application Publication
(10) Pub. No.: US 2018/0085275 A1
(43) Pub. Date: Mar. 29, 2018

(54) Method and Apparatus for Variable Knee Flexion Support

(71) Applicant: Xeras Medical Technologies, Inc., Boeme, TX (US)

(72) Inventors: Mark S. Malone, Boerne, TX (US); Cory R. A. Hallam, San Antonio, TX (US)

(21) Appl. No.: 15/676,844

(22) Filed: Aug. 14, 2017

Related U.S. Application Data
(60) Provisional application No. 62/374,664, filed on Aug. 12, 2016.

(51) Int. Cl. A61H 1/02; G09B 19/00

(52) U.S. Cl. CPC A61H 1/024; G09B 19/00; A61H 2201/1642; A61H 2201/0192; A61H 2203/0456; A61H 2201/0157; A61H 2205/104

(57) ABSTRACT

A device and system for promoting knee flexion may comprise a support bar and a plurality of pads removably mounted thereto, such that sequential use of the plurality of pads may progressively allow a knee joint to move through an increased range of motion. The knee joint flexion device and system may comprise a knee joint support mounted to a base. The base may comprise a variety of structures, such as those configured for use in connection with a patient support surface.

### CROSS-REFERENCE TO RELATED APPLICATION

This application claims priority to U.S. Provisional Patent Application 62/374,664 entitled “Method and Apparatus for Variable Knee Flexion Support” filed Aug. 12, 2016, which is hereby entirely incorporated herein by reference.

### FIELD

The disclosed method and apparatus generally relate to physical therapy for knee joints.

### BACKGROUND

The anatomy of a knee joint consists of three bones. These three specific bones are the femur (thighbone), the tibia (shinbone) and the patella (kneecap). The patella is located in front of the knee joint, and provides partial protection for the anterior portion of the knee. Typically, bones are connected to other bones through ligaments. Specifically, the knee joint has four ligaments functioning as resilient elastic cables linking the femur and tibia together for the purpose of maintaining knee joint stability.

Collateral ligaments are located vertically on opposed parallel sides of the knee joint. The medial collateral ligament is located on the outer inside of the knee joint, and links the femur and tibia. The lateral collateral ligament is located on the outer outside of the knee joint, and also links the femur and tibia. The purpose of the collateral ligaments is towards controlling knee joint sideways motion, thus fortifying the knee joint against unusual movement.

Cruciate ligaments are located inside of the knee joint, and cross each other in the general form of an “X”. The anterior cruciate ligament is located in front, behind the patella, and the posterior cruciate ligament is located in the back, linking the femur and tibia and having a purpose towards controlling anterior and posterior movement of the knee joint.

Upon completion of knee joint surgery or other type of knee joint treatment, such as knee joint replacement or replacement or repair of any torn or damaged previously described ligaments, bone fracture and bone fracture surgery, or internal fixation surgery, or for treatment of arthritic conditions, or meniscus repair, or for knee injury recovery, regaining normal knee joint flexibility, range of motion and strength typically requires a physical therapy rehabilitation program.

Following knee surgery, or arthritic treatment, or injury treatment, or other procedure or course of treatment for the knee joint, physical therapy may be beneficially applied to restoring full and painless motion of the knee joint, along with re-establishing associated ligament and muscle suppleness. Restoration may be followed by a knee joint strengthening program focused on regaining normal function of the knee joint. A physical therapy program progressively stretches muscle(s) and tendon(s) to their former flexibility. A final rehabilitation phase encourages complete return of normal knee joint functionality.

There remains a need for an apparatus and method for a knee joint flexion support allowing for incrementally-applied physical therapy.

### SUMMARY

A knee flexion rehabilitation device may comprise a knee support system and a base which connects to and supports the knee support system, wherein the knee support system may comprise a knee support bar and a plurality of pads configured to removably mount to the knee support bar, further wherein each pad has an outer diameter different from that of another of said plurality of pads.

A knee flexion rehabilitation device may comprise a plurality of knee support bars, each knee support bar having an outer diameter different from that of another of said plurality of knee support bars; and a plurality of pads, each pad being configured to mount to at least one of said plurality of knee support bars.

A base of a knee flexion rehabilitation device may comprise a bracket system to mount the knee support system to a patient support system, such as a bed or therapy table. Other embodiments of a base may exist so as the knee flexion rehabilitation device is self-supporting and mobile.

A method for using a knee flexion rehabilitation device may comprise establishing a support bar, effectively increasing the diameter or a cross-section dimension of the support bar by attaching one or more pads thereto, supporting a knee joint on the dimensionally-enlarged support bar for initial flexibility treatment, reducing the diameter or a cross-section dimension of the support bar by removing or changing one or more pads, and supporting a knee joint on the dimensionally-selected support bar for subsequent flexibility treatment. The ability to select the support bar's effective diameter may allow for optimal therapeutic outcomes for differing situations, procedures, and protocols.

The above brief description sets forth rather broadly certain features of the disclosed apparatus in order that the description thereof that follows may be better understood, and in order that the present contributions to the art may be better appreciated. There are, of course, additional features of the disclosed apparatuses that will be described hereinafter and which will, in whole or in part, form the subject matter of the claims appended hereto.

Thus, it is to be understood that the disclosed subject matter is not limited in its application to the details of the construction and to the arrangements of the components set forth in the following description or illustrated in the drawings. The disclosed subject matter is capable of other embodiments and of being practiced and carried out in various ways, including being fabricated with fixed dimensions, non-folding components, or other structural locking mechanisms. Also, it is to be understood, that the phraseology and terminology employed herein are for the purpose of description and should not be regarded as limiting.

As such, the concepts upon which this disclosure is based may readily be utilized as a basis for designing other structures, methods, and systems for carrying out several purposes of the disclosed subject matter. It is important, therefore, that the claims be regarded as including such equivalent constructions insofar as they do not depart from the spirit and scope of the subject matter described herein.

### BRIEF DESCRIPTION OF THE DRAWINGS

FIG. 1 provides a perspective view of an embodiment of a knee support system mounted to a patient support surface.

FIG. 2 provides another view of the embodiment of FIG. 1.

FIG. 3 illustrates various degrees of freedom of the embodiment of FIG. 1.

FIG. 4 illustrates yet another embodiment of a knee support system.

FIG. 5 illustrates a further embodiment of a knee support system.

FIG. 6 illustrates another embodiment of a knee support system.

FIG. 7 illustrates yet another embodiment of a knee support system.

FIG. 8 illustrates a further embodiment of a knee support system.

FIG. 9 illustrates an embodiment of a knee support system.

FIG. 10 illustrates another embodiment of a knee support system.

FIG. 11 illustrates a further embodiment of a knee support system.

FIG. 12 provides a perspective view of the embodiment of FIG. 11.

FIG. 13 illustrates another embodiment of a knee support system.

FIG. 14 illustrates a further embodiment of a knee support system.

FIG. 15 illustrates yet a further embodiment of a knee support system.

FIG. 16 illustrates an adjustable base.

FIG. 17 illustrates one embodiment of a knee flexion rehabilitation device for knee flexion support.

FIG. 18 illustrates another embodiment of a knee flexion rehabilitation device for knee flexion support.

FIG. 19A-C illustrates a system and method of pads having different thicknesses for knee flexion support.

FIG. 20 illustrates an embodiment of a pad having resilient support members.

FIG. 20A illustrates example angles of use of the embodiment of FIG. 20.

FIG. 21 illustrates an embodiment of a plurality of pads, each having nested wings.

FIG. 22A-C illustrates a method of using the embodiment of FIG. 16 to promote knee flexion.

FIG. 23A-C illustrates a system and method of support bars having different diameters for knee flexion support.

### DETAILED DESCRIPTION

Disclosed is a knee flexion rehabilitation apparatus and method adapted for knee joint flexion rehabilitation following knee joint surgery or other type of knee joint treatment, such as knee joint replacement or replacement or repair of any torn or damaged previously described ligaments, bone fracture and bone fracture surgery, or internal fixation surgery, or for treatment of arthritic conditions, or meniscus repair, or for knee injury recovery, regaining normal knee joint flexibility, range of motion and strength. The apparatus is capable of use for reducing muscle spasm, pain and swelling; having such arrangement to provide appropriate flexion support of the posterior intersection concerning the femur and tibia of a non-operative, arthritic, injured, fractured, or post-operative recovering knee joint; promoting deliberate gravity assisted passive flexion towards gradual knee joint muscle and tendon stretching, and mechanical decompression of the knee joint to alleviate pain, pressure, swelling, and general discomfort.

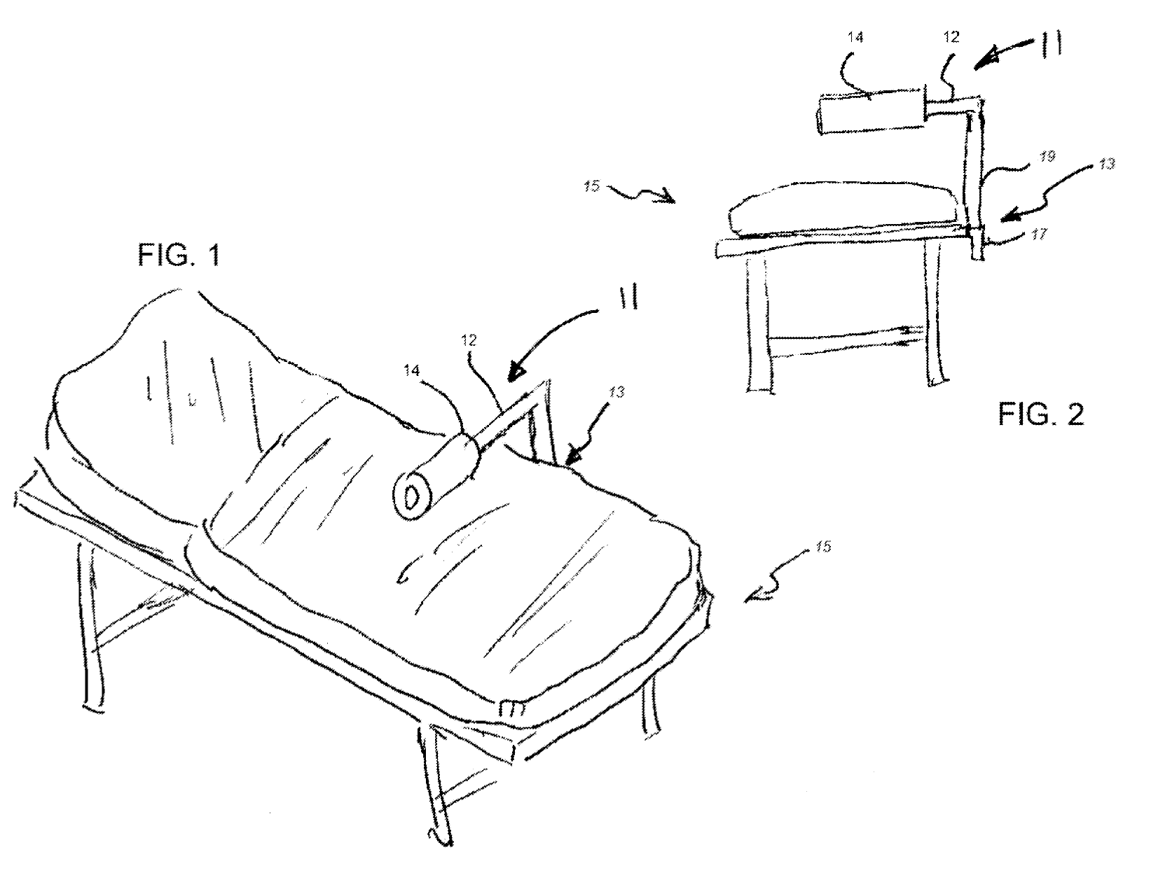

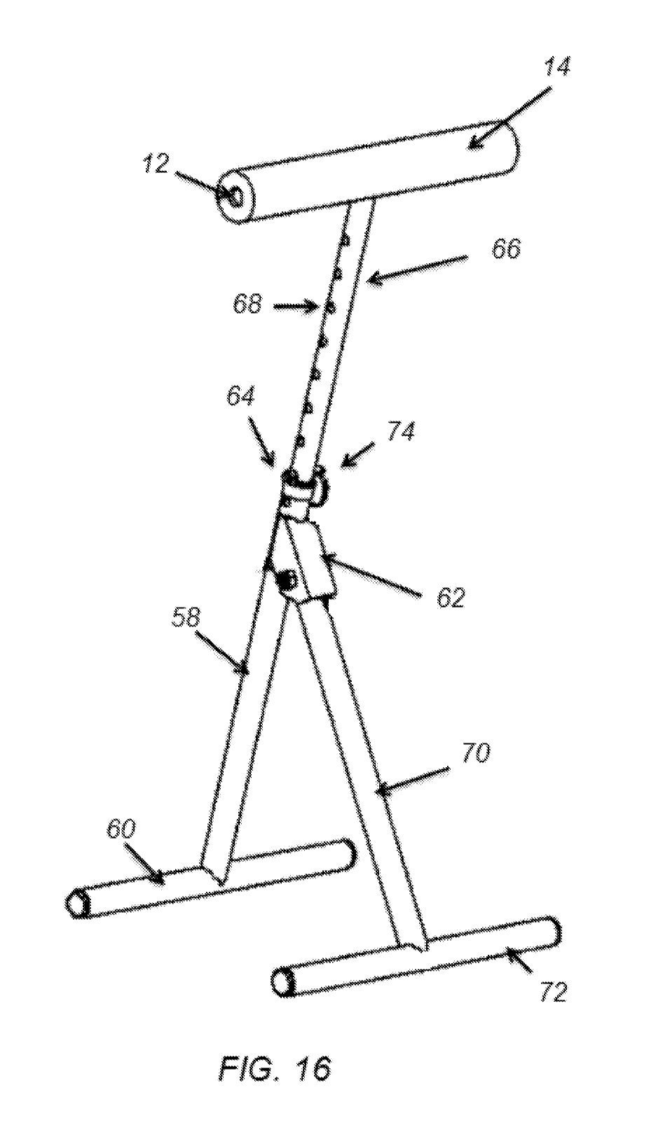

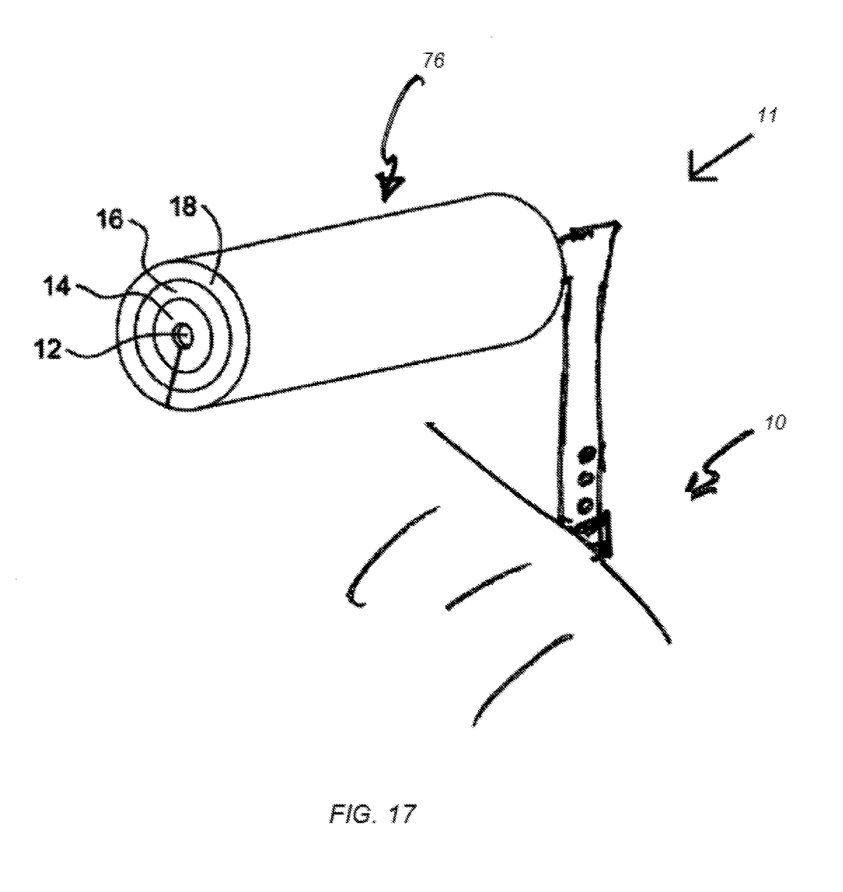

The knee flexion rehabilitation device 10 in general may comprise of three main assemblages, the knee support system 11 and a base 13. In some embodiments, such as seen in FIGS. 1 and 2, for example, the knee support system 11 may be connected to and supported by a base 13 wherein said base 13 may be mounted to any suitable patient support surface 15, such as a hospital bed. The knee support system 11 may comprise one or more supple pads as described herein (such as pads 14, 16, 18 of FIG. 16) encompassing all or part of the length of a knee posterior support bar 12, and may partially or fully encompass the circumference of the support bar 12. The one or more pads may be feasibly detained, by some form of bonding agent (e.g., glue, double-sided tape, stitching, hook-and-loop fastener, magnets, or some other commercially available attachment means) or simply by friction, mechanical pressure, or any combination of the afore mentioned attachment modalities.

The knee posterior support bar 12 may be substantially oriented parallel to the patient support surface 15, which may be substantially horizontally oriented. The knee support system 11 may further comprise a strut 19 configured to position the support bar 12 over or near the patient support surface 15. The support bar 12 and the strut 19 may be mechanically joined, or formed as a unitary structure. In some embodiments, the support bar 12 and strut 15 may comprise hollow tubular members.

FIG. 2 illustrates an elevation view of the embodiment of FIG. 1. The strut 19 may be mounted to a bed using a mounting bracket 17. The strut 19 may be rotatably mounted to the mounting bracket 17, or may be non-rotatably mounted to the mounting bracket 17. In some embodiments, the strut 19 may be removable from the mounting bracket 17. Embodiments as such described may consider the base 13 to comprise of the mounting bracket 17 and any such related hardware.

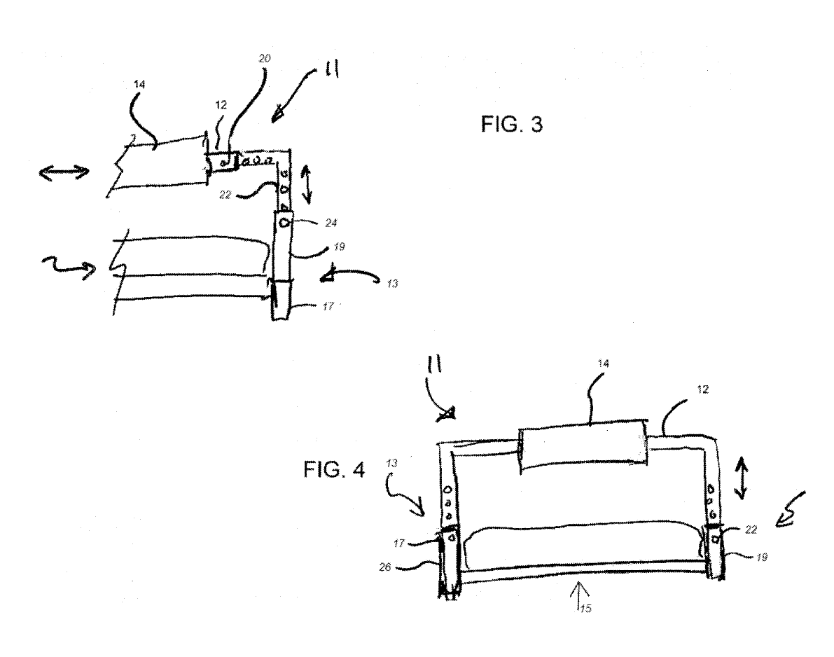

FIG. 3 illustrates an embodiment of a knee support system 11 which is connected to and supported by a base 13. The knee support system 11 may be configured for multiple degrees of adjustment. The support bar 12 may comprise horizontal telescoping sections that may allow translation of the pad 14 in a substantially parallel fashion with respect to the patient support surface 15. The horizontal telescoping sections may comprise one or more apertures 20 which may be used to lock the support bar 12 in a horizontal position by using a pin (not shown), a spring-loaded detent, or any other suitable locking mechanism.

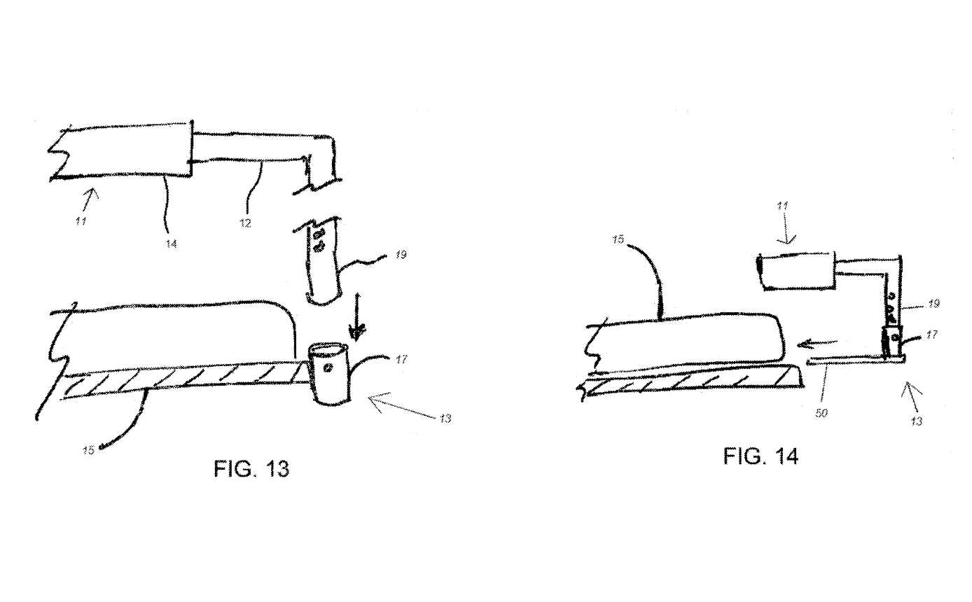

In some embodiments, such as in the embodiment of FIG. 3, the strut 19 may comprise other telescoping sections that may allow translation of the pad 14 in a substantially perpendicular or vertical fashion with respect to the patient support surface 15. The vertical telescoping sections of the strut 19 may comprise one or more apertures 22 which may be used to lock the support bar at a particular distance from the patient support structure 15 by using a pin (not shown), spring-loaded detent, or any other suitable locking mechanism. In other embodiments, the strut 19 may simply translate within a mounting bracket, such as mounting bracket 17 of the embodiment of FIG. 1 or FIG. 13, in which case the mounting bracket 17 may be provided with one or more apertures configured to align with one or more apertures 22 of the strut 19. If a pin (not shown) is placed through a bracket aperture 24 and through aligned apertures 22 of the strut 19, then the strut 19 may be fixed against both translation and rotation with respect to the mounting bracket 17. If a pin is place only through apertures 22 in the strut 19, then the strut 19 may be partially fixed against translation with respect to the mounting bracket 17, but may freely rotate within said mounting bracket 17.

FIG. 4 illustrates another embodiment of a knee support system 11, similar to the embodiment of FIG. 3, that may be comprised of a plurality of struts which are adjustably connected to and supported by a base 13. In the embodiment of FIG. 4, a second strut 26 may be provided so that both ends of support bar 12 are supported against the weight of a patient leg that may be applied at the pad 14.

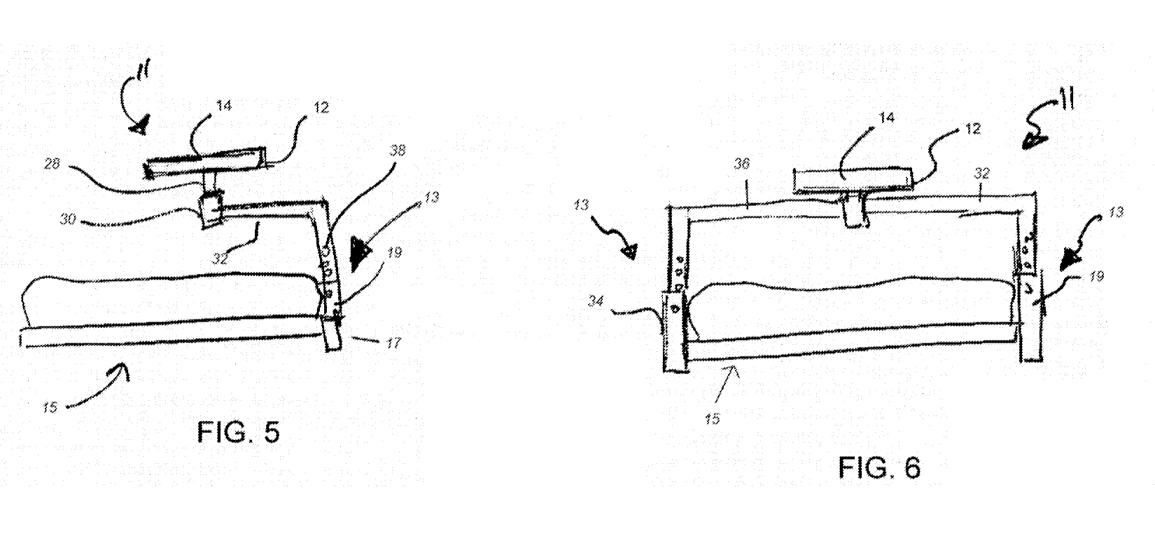

In other embodiments, the support bar 12 may rotate about a different axis than that of the strut 19. As may be seen in FIG. 5, knee support system 11 which is connected to and supported by a base 13 may be comprised of support bar 12 which may further be comprised of a post 28. The post 28 may be disposed along the support bar 12 at any suitable point. In FIG. 5, the post 28 is shown as disposed approximately mid-way along the length of the support bar 12. Of course, the post 28 may be disposed at any other point along or at an end of the length of the support bar 12. The post may be received in a socket 30 disposed at the end of or at some point along a strut arm 32. The strut arm 32 may extend approximately perpendicularly from the strut 19, or may extend from the strut 19 at any other angle of incidence with the strut arm 32.

In various embodiments, the post 28 may rotate in the socket 30. The post 28 may translate in the socket 30. The post 28 may rotate and translate in the socket 30, depending on embodiment. Alternately, the post 28 may be fixed against rotation or translation in the socket 30 via apertures 38 and pin (not shown), or detents, or other suitable locking mechanism. Thus, the knee support system 11 may rotate on one or more axes, and may translate in a variety of planes so as to accommodate a wide range of patient sizes, weights and conditions, and to accommodate a wide range of treatment protocols. Additionally, the socket 30 may translate along the strut arm 32 to further aid in proper positioning in relation to a supine or sitting patient.

An embodiment, as seen in FIG. 6, may be an extension of the embodiment of FIG. 5 wherein a base 13 may be further comprised of a second strut 34 having a second strut arm 36, so that the support bar 12 is supported against the weight of a patient leg. In such an embodiment, a socket 30 and post 28 for rotatably and translatably mounting the support bar 12 to the struts 32 and 36 may allow the support bar 12 to rotate on at least one axis, thus allowing a greater range of treatment protocols. Furthermore, in such an embodiment, socket 30 may be translated along strut arm 32 and second strut arm 36 and then locked into a position via apertures 38 and pin (not shown), or detents, or other suitable locking mechanism.

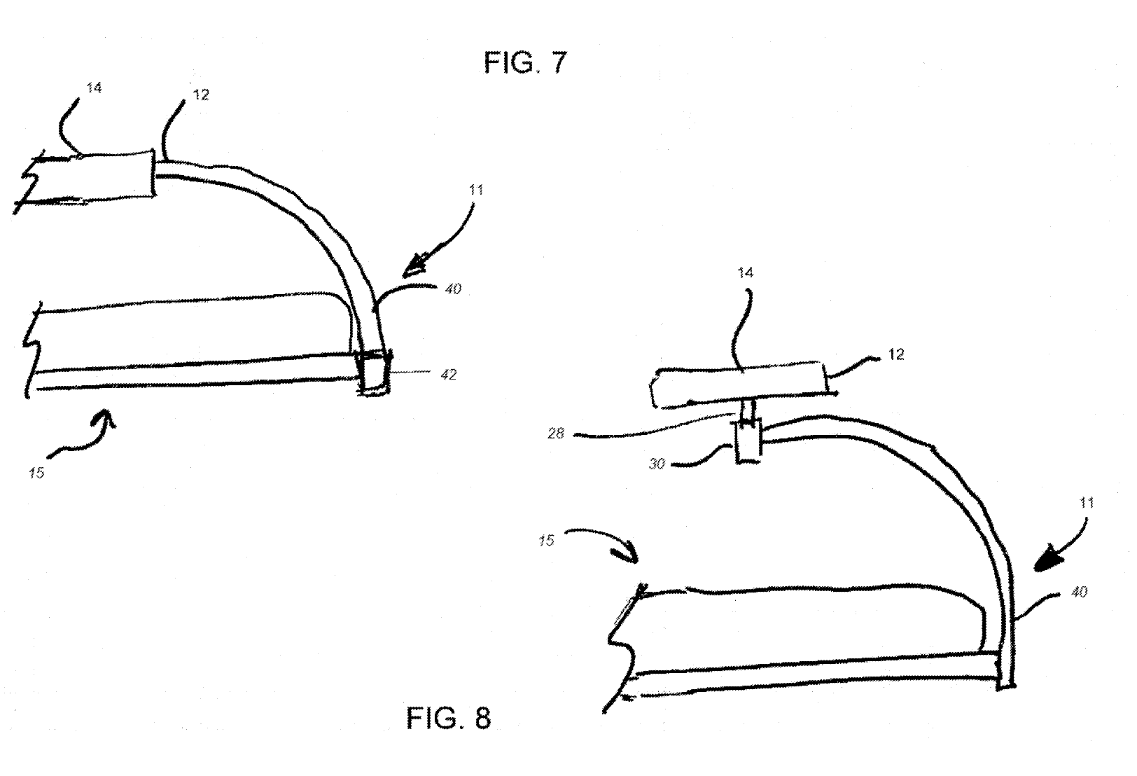

In yet other embodiments, such as the embodiment illustrated in FIG. 7, the knee support system 11 may comprise a curved member 40 extending from a mounting bracket 42 into which said member 40 couples and then terminating at the upper end of said member 40 into the support bar 12 over which a pad 14 may be disposed. Such a configuration may provide a more aesthetically pleasing structure, and may reduce the structural points and edges upon which clothing, equipment or limbs may be caught or injured. In such embodiments, the curved member 40 may rotate and/or translate in the mounting bracket, and the one or more supple pads 14 may rotate about and/or translate along the support bar 12 portion of the knee support system 11. Similar to the embodiments of FIGS. 4 and 6, a second curved member (not shown) may, in some embodiments, be provided to support the free end of a support bar 12 portion of the knee support system 11.

In some embodiments, a socket 30 may be disposed at one end of the curved member 40 of base 13. As in the embodiment of FIG. 5, the support bar 12 may comprise a post 28 configured for reception by a socket 30. The post 28 may be disposed along the support bar 12 at any suitable point. In FIG. 8, the post 28 is shown as disposed approximately mid-way along the length of the support bar 12. The post 28 may rotate in the socket 30. The post 28 may translate in the socket 30. The post 28 may rotate and translate in the socket 30. As described in connection with other embodiments, the post 28 may be fixed against rotation and/or translation in the socket 30 via apertures (not shown) and pin (not shown), or detents, or other suitable locking mechanism.

In other embodiments, the disclosed apparatus, referred to as knee flexion rehabilitation device, may generally be comprised of a knee support system 11 connected to and supported by a base 13. The disclosed device and system may comprise a plurality of pads for a knee flexion support bar. The support bar may be substantially straight, or may comprise one or more curves. The support bar may be provided as part of a knee flexion rehabilitation device, such as that disclosed in PCT/US15/19336, filed Mar. 7, 2015, and entitled Method and Apparatus for Knee Joint Flexibility Rehabilitation, the entire disclosure of which is incorporated herein by reference. Those having skill in the art will appreciate that the pads may be used with any other suitable support bar such as those described herein.

The preceding paragraphs have described various embodiments of the knee flexion rehabilitation device with the focus largely on the various embodiments of the knee support system. For purposes of simplicity, the drawings may have included a particularly simple and effective base. In the following paragraphs, an embodiment that describes that base with more specificity and other embodiments focusing on the base are described. It will be readily understood that any of the above described embodiments of the knee support system can be used with, or adapted to be used with, any of the below described embodiments of the base to construct a knee flexion rehabilitation device and provide incremental knee therapy.

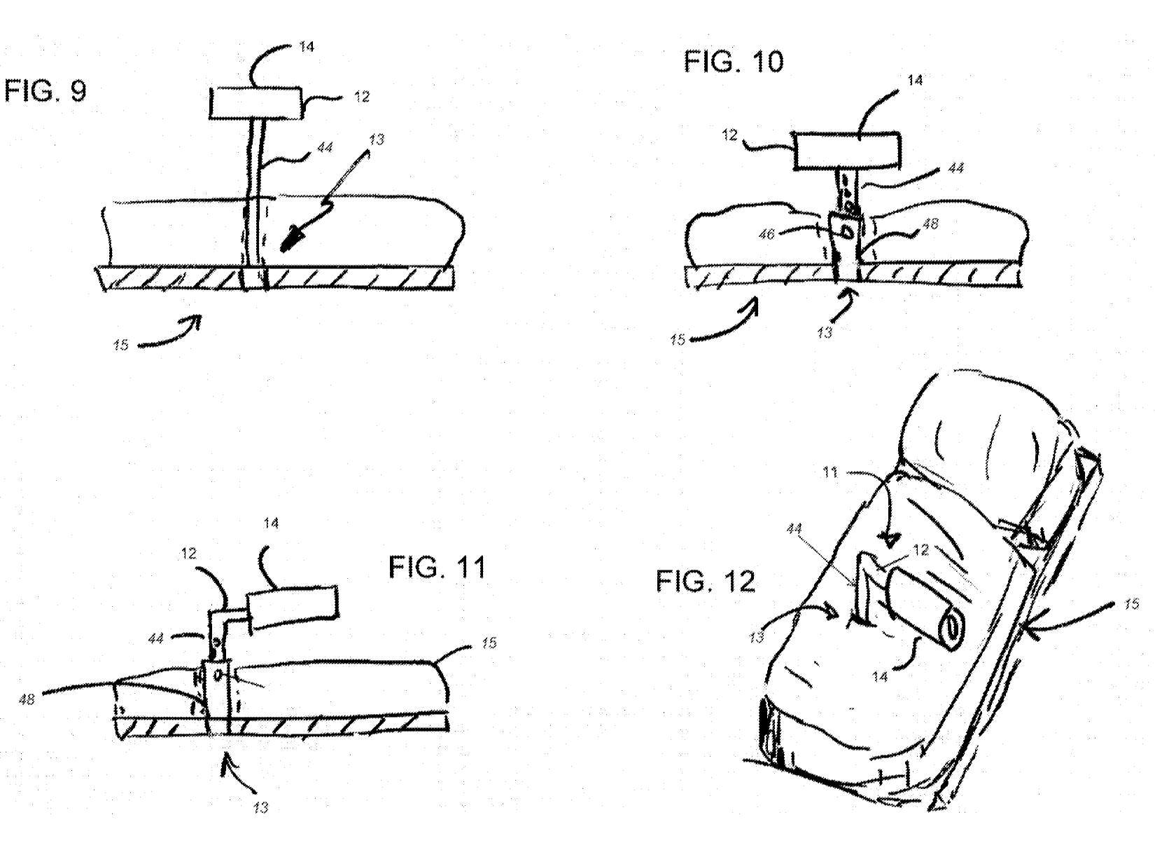

In some embodiments, the base may comprise a strut 44 extending from a patient support surface 15, as may be seen in the embodiments of FIGS. 9, 10, 11 and 12, rather than extending from a point adjacent the patient support surface 15 as briefly described in prior embodiments. In the embodiment of FIGS. 9 and 12, base 13 may comprise a strut 44 extending from a patient support surface 15 wherein the strut 44 is of a fixed height from the patient support surface 15. The strut 44 may extend approximately perpendicularly from the support surface 15, or may extend from the patient support surface 15 at any suitable angle. A support bar 12 may be mounted to the strut 44 so as to substantially form a ‘T’ or otherwise be oriented substantially horizontally to the patient support surface 15. The support bar 12 may be rotatably mounted to the strut 44. The strut 44 may be rotatable with respect to the patient support surface 15. A system of one or more supple pads 14 may fully or partially cover the support bar 12.

As may be seen in the embodiments of FIGS. 10 and 11, base 13 may comprise a strut 44 which may be translatable with respect to the patient support surface 15 so as to allow the support bar 12 to be moved closer to or farther away from the patient support surface 15. The strut 44 may also be rotatable with respect to the patient support surface 15. The strut 44 may be translatably and rotatably disposed in a mounting bracket 48. Apertures 46 may be provided in the strut 44 and a mounting bracket 48 so as to allow the strut 44 to be fixed against rotation, or partially fixed against translation and thus lock in a desired positioning configuration to meet the needs of the patient and practitioner.

In some embodiments, the support bar 12 may be mounted to the strut 44 at one end of the support bar 12, as may be seen in the embodiment of FIGS. 11 and 12. In other embodiments, the support bar 12 may be mounted to the strut 44 at an approximate midpoint of the support bar 12, as may be seen in the embodiments of FIGS. 9 and 10.

In yet further embodiments, a knee support system 11 which is connected to and supported by a base 13, may be mounted to the edge of a patient support surface 15, such as in the embodiment of FIG. 13. The strut 19 may be configured for translatable and rotatable insertion into a mounting bracket 17. This strut 19 may be a unitary body approximately formed into an “L” shape so as to present a support bar 12 parallel to the patient support structure 15 while maintain a vertical portion for mating with bracket 17. Said support bar 12 may be whereat a pad 14 is disposed.

As may be seen in FIG. 14, the mounting bracket 17 may itself be configured for removable mounting from the patient support surface 15. For example, the patient support surface 15 may comprise a mattress and base between which a mounting bracket flange 50 may be disposed. Thus, a knee support system 11 which is connected to and supported by a base 13 may be entirely removable from a patient support surface 15, and may be used with any suitable patient support surface.

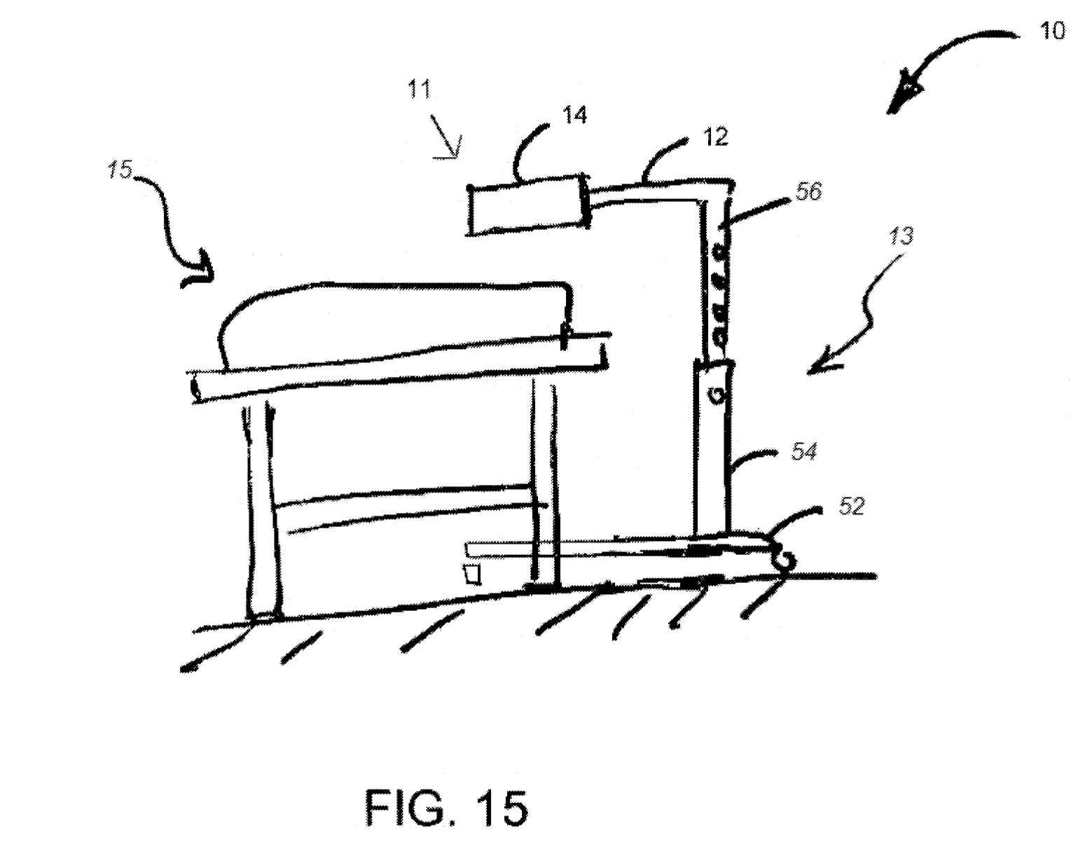

In other embodiments, such as that of FIG. 15, a knee flexion rehabilitation device 10 may comprise a base 13 which may further comprise a base stand 52 configured so as the entire device 10 is self-supporting. The base stand 52 may be provided with wheels, bearings, or other rolling mechanisms for easy mobility. Alternately, the base 13 may have sliders or rails, or simply comprise a planar surface for stability. The base stand 52 may extend beyond a point located beneath the support bar to prevent tipping. The base stand 52 may have a receiving tube 54 affixed thereto for receiving a strut 56. A support bar 12 may be mounted to the strut 56 as described above, and one or more supple pads 14 may be disposed about the support bar 12. A knee flexion rehabilitation device 10 comprised of a base 13 provided with such a base stand 52 may allow for use of the knee support system 11 with a wider variety of patient support surfaces 15.

The base 13 may be provided as part of a knee flexion rehabilitation device 10, such as that disclosed in PCT/US15/19336, filed Mar. 7, 2015, and entitled Method and Apparatus for Knee Joint Flexibility Rehabilitation, the entire disclosure of which is incorporated herein by reference. In the embodiment of FIG. 16, a base 13 of a knee flexion rehabilitation device 10 may comprise a tubular strut 58 having a first support foot 60 and a bracket 62 attached thereto, the tubular strut 58 forming a first aperture 64; a height-adjustment bar 66 translatably and rotatably disposed in the tubular strut 58, the height-adjustment bar 66 forming a plurality of second apertures 68 extending through the diameter of the height-adjustment bar 66. A support bar 12 may be fixed substantially perpendicularly to the height-adjustment bar 66, the support bar 12 being configured to receive a knee joint posterior; a plurality of pads configured to removably mount to the support bar 12, each pad 14 having an outer diameter different from that of prior of said plurality of pads. The base 13 may further comprise support strut 70 pivotably connected to the bracket 62, the support strut 70 having a second support foot 72 attached thereto, the support strut 70 pivotable away from parallel the tubular strut 58 to form an acute angle thereto; and a pin 74 removably disposed in one of the plurality of second apertures 68 to fix the height-adjustment bar 66 against translation in one direction.

The preceding paragraphs have described various embodiments of the knee flexion rehabilitation device with the focus largely on the various embodiments of the knee support system or base. For purposes of simplicity, the drawings may have included a particularly simple and effective pad system. In the following paragraphs, an embodiment that describes that pad system with more specificity and other embodiments focusing on the pad system are described. It will be readily understood that any embodiments of a knee support system can be used with, or adapted to be used with, any of the embodiments of a pad system to construct a knee flexion rehabilitation device and provide incremental knee therapy.

The pads may comprise any suitable material, such as foam, plastic, fabric, gel, and the like. Similarly, the pads may be solid, inflatable, hollow, or contain internal structural components for rigidity and shape. The pads may comprise any suitable density, stiffness and elasticity desired for patient comfort and condition. For example, a system of pads may comprise pads having a density and compliance configured to meet needs of specific patient conditions (such as arthritis, TKA, meniscus repair, ligament repair, broken bone recovery, for example). Those having skill in the art will appreciate that some surgeries and uses may require softer layers depending on the sensitivity and severity of the condition of the knee joint and surrounding patient tissue, as well as the presence and location of sutures and bandages, and degree of swelling.

The pads may further comprise any suitable coating and outer surface texture. In some embodiments, the pads may be sterilizable for re-use, or may be disposable. In yet other embodiments, the pads may comprise a substantially breathable surface to allow moisture and patient fluids to wick away from the leg. In yet further embodiments, the pads may comprise impermeable surfaces that may be cleaned. In other embodiments, a disposable cover may be placed over one or more of the pads. In further embodiments, a pad or outer layer may be coated with balm or medicated salve to promote patient comfort or healing (such as for heating or cooling, or a such as a lotion, lubrication, or pain relief medication).

Furthermore, the pads may be suitably shaped to cradle the knee joint, or to provide a smaller fulcrum point. The effective diameter of the support bar may be changed by pads having substantially uniform thickness, or may be changed by pads having varying thickness. The cross-sectional shape of the pads may be round, square, rectangular, triangular or have a different polygonal shape, or may be irregularly shaped. The support bar may be tubular, or round. If the pads are irregularly shaped, or have a varying thickness, the support bar may be square or keyed to substantially prevent the pad from slipping about the support bar. Thus, the pads may effectively increase a radius or cross-sectional dimension of the support bar. The pads may be removably affixed to the support by any suitable device, such as hook-and-loop fastener, interlocking surface texture, interlocking configuration, adhesive, friction fit, the weight of the patient's leg, pins, screws, clamps, or straps.

In some embodiments, the one or more supple pads 14 may translate along the support bar 12 for any embodiment of the knee support system 11. In other embodiments, the one or more supple pads 14 may rotate about the support bar 12. In yet other embodiments, the one or more supple pads 14 may rotate about and translate along the support bar 12. These features may be the most readily apparent in FIG. 4.

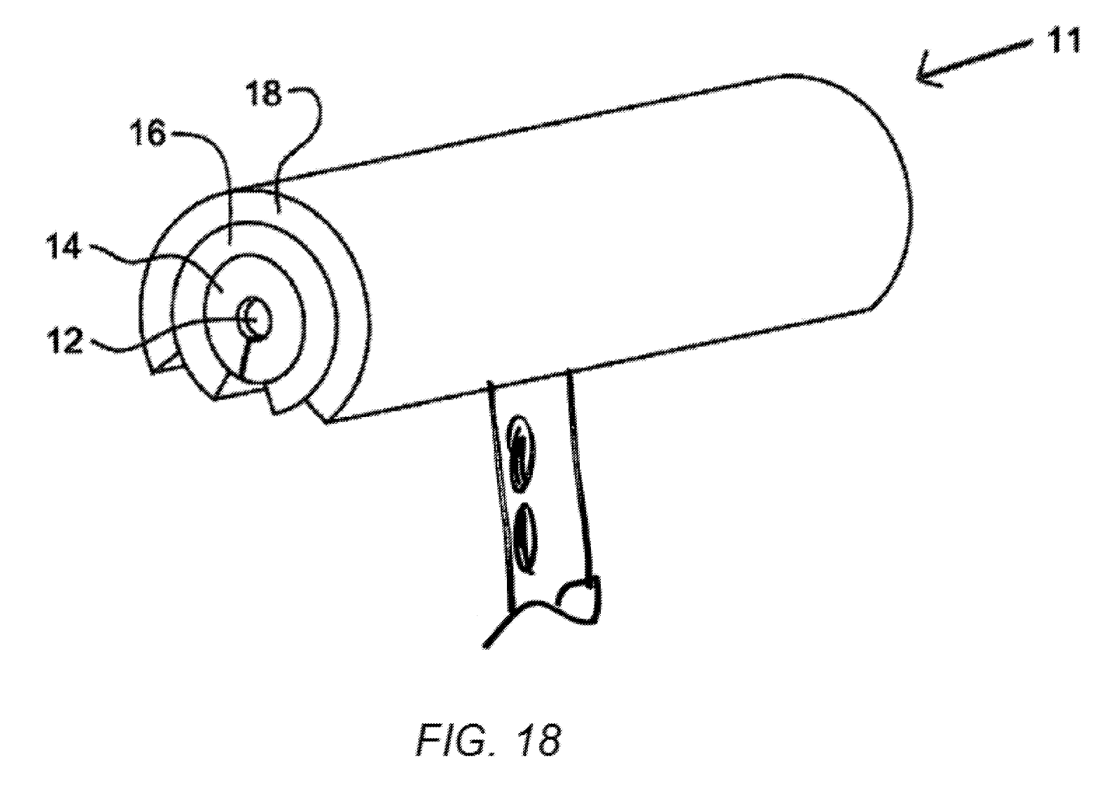

As may be seen in the embodiment of FIG. 17, a knee flexion rehabilitation device 10 may comprise a support bar 12 upon which a knee may rest. A knee support system 11 may utilize a pad system 76 of one or more pads 14, 16, and 18 may be deployed as described herein to permit incremental knee flexion. In one embodiment, the system may comprise a nested arrangement of pads 14, 16, and 18 in layers. These pads 14, 16, and 18 may be of a nature as those previously disclosed or of any other appropriate embodiment. In such an embodiment, a base pad 14 may cover the support bar 12 as the first pad layer 14. A second pad layer 16 may cover the first pad layer 14, and a third pad layer 18 may cover the second pad layer 16. In FIG. 17, the layers are illustrated as wrapping around substantially the entire support bar 12 circumference. In other embodiments, one or more pads 14, 16, and 18 may partially wrap around the support bar circumference, as shown in the embodiment of FIG. 18. In the embodiments of FIGS. 17 and 18, each pad 14, 16, and 18 may have equal or different thicknesses than the next.

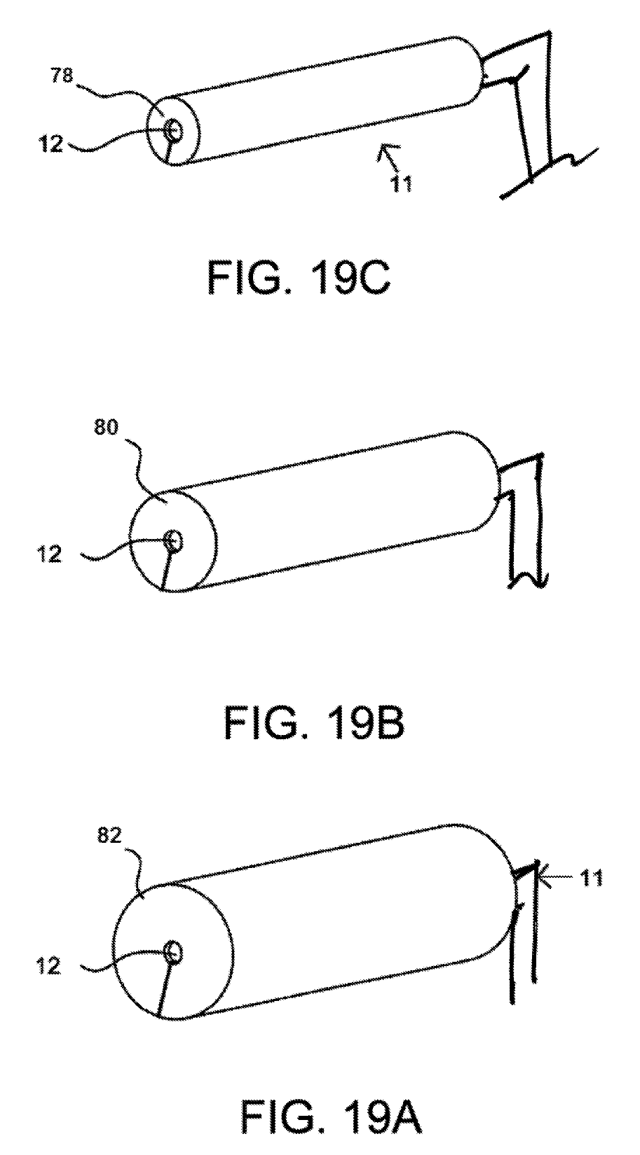

In other embodiments, a system of pads may be provided, with each pad having a different thickness, as in the embodiment of FIG. 19A-C. Therein, three pads 78, 80, and 82 may provide for individual use of a particular pad 78, 80, and 82 on a support bar 12 at a given phase of a therapy protocol. Each of the three pads 78, 80, and 82 having a different thickness thus provide a different effective diameter for the support bar 12 dependent on the pad 78, 80, and 82 78, 80, and 82 currently disposed on the bar 12. For example, instead of using first, second, and third pad layers 14, 16, and 18 (FIG. 17) to effectively increase the diameter of the support bar 12, a single pad 82 (FIG. 19A) may be independently used to effectively achieve that same effective diameter provided by nesting pads 14, 16, and 18. Similarly, a single pad 80 (FIG. 19B) may be used to achieve the same effective diameter provided by first and second pad layers 14 and 16 of FIG. 17, and a single pad 78 (FIG. 19C) may be used to achieve the same effective diameter provided by first pad layer 14 of FIG. 17.

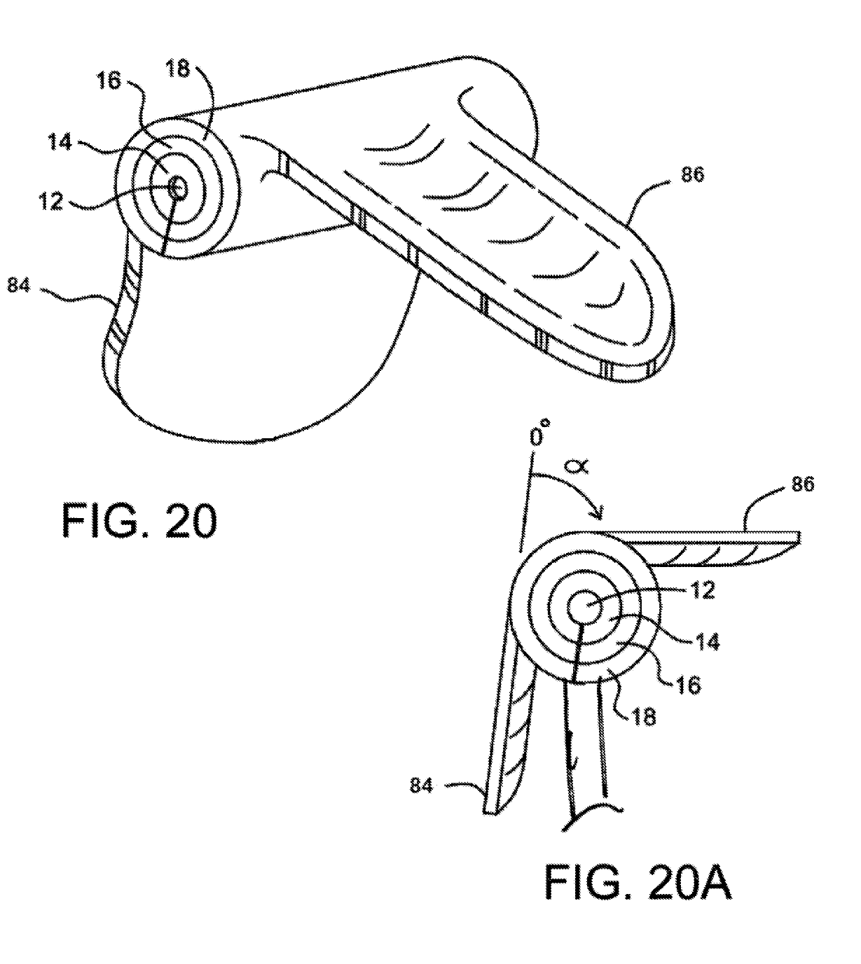

In some embodiments, one or more of the pads 14, 16, and 18 may be provided with one or more wings 84 and 86 against which the femur and/or tibia may rest to further control range of motion. Each wing 84 and 86 may extend from a pad 14, 16, or 18 at a tangent thereto. A single-wing embodiment may be keyed to the support bar 12 so as to substantially restrict rotation of the wing 84 or 86 about the support bar 12. In the embodiment of FIG. 20, the outer layer pad 18 may comprise a femur support wing 84 and a tibia support wing 86 that may further support a patient's leg. When two wings 84 and 86 are used, the tibia support wing 86 may be positioned in a suitable angular range α from the femur support wing 84, as illustrated in FIG. 20A. Angular range α may be from about 0 degrees to about 120 degrees, or more particularly from about 20 degrees to about 100 degrees. The material of wing 84 and 86 construction may comprise any suitably rigid material or resilient material, such as foam, plastic, rubber, metal or fiberglass. The outer layer pad 18 may nest over an interior pad 16 which may in turn nest over an inner most pad 14.

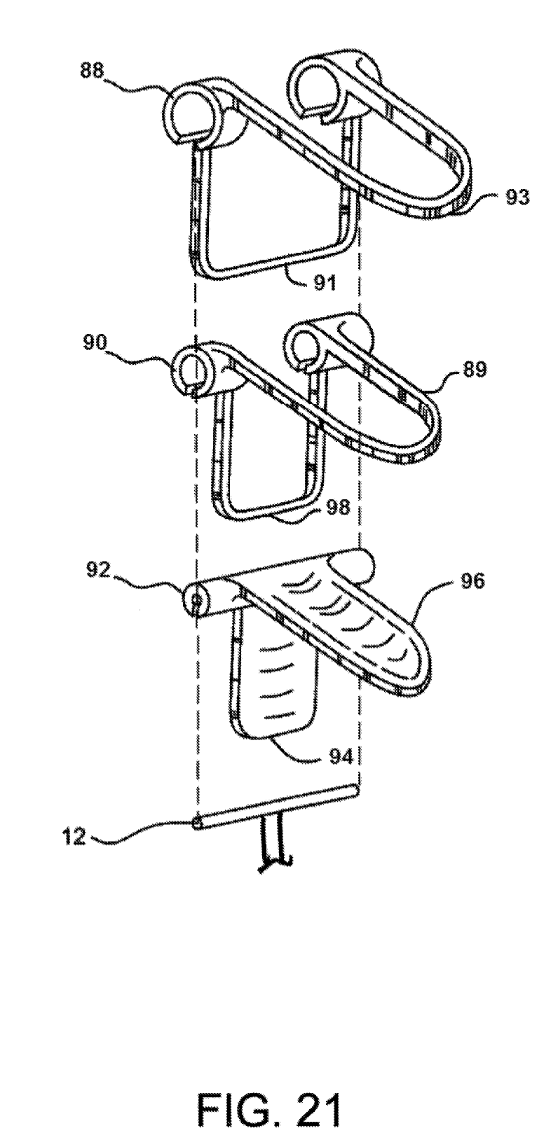

In some embodiments, such as those of FIG. 21, a system of layered pads 88, 90, and 92 may provide nestable support wings 89, 91, 93, 94, 96, and 98. Of course, one or more wings 89, 91, 93, 94, 96, and 98 may also be provided on pads 88, 90, and 92 configured for sequential mounting to a support bar 12, such as those pads 88, 90, and 92 depicted in FIG. 21.

In such an embodiment, the tibial wing 89 and 93 of the outer pad 88 and mid pad 90 of a “U” shaped arc of pad material such that when said pads are nested with the inner pad 92, the wings of the outer pads 88 and 90 do impede access to wing 96. Alternately, wings 89 and 93 may be disposed such that the U-shaped nature allows the overlap the outer edge of the preceding wing and thus the wings 96, 89, and 93 nest so as to form a single platform. These features as disclosed for the tibial wings 96, 89, and 93 hold for the femoral wings 91, 98, and 94.

Thus, a system of pads may provide for separate pad use, or may provide for pad layers. The pads may be color-coded, textured, labeled, or otherwise suitably marked to indicate the approximate range of angles provided by the pad, and/or to indicate the order of use. By varying the effective diameter of the support bar, the physical therapist (or patient, or doctor or other caregiver, as the case may be) may allow therapy to progress through each layer or pad size based on the patient's level of comfort, thus better allowing for a patient-specific recovery regimen. A system may provide a plurality of pads having dimensions suitable for allowing finer or coarser increments between ranges of motion. For example, a system of five layered pads may provide the same effective diameter as a system of three layered pads, but may provide smaller range-of-motion increments than the three-layer system. Similarly, a system of five pads for sequential placement on the support bar may provide the same maximum effective diameter as a system of three pads, but may provide smaller range-of-motion increments than the three-pad system.

For example, a system of four layered pads may comprise a first pad having an outer diameter of about 1.5 inches and configured to mount to a support bar, a second pad having an outer diameter of about 2.5 inches and configured to nest over the first pad, a third pad having an outer diameter of about 3.5 inches and configured to nest over the second pad, and a fourth pad having an outer diameter of about 4.5 inches and configured to nest over the third pad. The first pad may be color-coded red and labeled with a range-of-motion (ROM) marking indicating a range of motion up to about 90 degrees (as measured by a goniometer). The second pad may be color-coded blue and labeled to indicate a ROM of up to about 105 degrees. The third pad may be color-coded green and labeled to indicate a ROM of up to about 120 degrees. The fourth pad may be color-coded purple and labeled to indicate a ROM of up to about 135 degrees. Of course, any number of such pads may be used in a variety of thicknesses to provide desired ranges of motion.

In another example, a system of three pads may comprise a first pad having an outer diameter of about 1.5 inches and configured to mount to a support bar, a second pad having an outer diameter of about 3.0 inches and configured to mount to a support bar, a third pad having an outer diameter of about 4.5 inches and configured to mount to a support bar. The first pad may be color-coded red and labeled with a range-of-motion (ROM) marking indicating a range of motion up to about 90 degrees (as measured by a goniometer). The second pad may be color-coded blue and labeled to indicate a ROM of up to about 112.5 degrees. The third pad may be color-coded green and labeled to indicate a ROM of up to about 135 degrees. Of course, any number of such pads may be used in a variety of thicknesses to provide desired ranges of motion.

A system of pads may thus comprise a kit having a plurality of pads, and instructions for use. A pad carrier may be provided to allow for ready arrangement, transportation, storage and deployment of the system. The pad carrier may allow for ready visual identification of each pad. Instructions may be printed on the pads, and/or separately provided in a manual. The pads may be provided as part of a knee flexion rehabilitation device, or as a separate system. The system may be configured for use with any other suitable support bar, such as the back of a chair or the edge of a table, chair or bed.

Similarly, a knee flexion rehabilitation device system may comprise a kit having a plurality of support bars, and instructions for use. A knee flexion rehabilitation device system carrier may be provided to allow for ready arrangement, transportation, storage and deployment of the system. The knee flexion rehabilitation device system carrier may allow for ready visual identification of each support bar. Instructions may be printed on the support bars, and/or separately provided in a manual. The support bars may be provided as part of a knee flexion rehabilitation device system, or as a separate system expansion kit. The system may be configured for use with any other suitable support system.

In yet further embodiments, a system of pads and support bars may comprise a kit having a plurality of pads and support bars, and instructions for use. A pad and support bar carrier may be provided to allow for ready arrangement, transportation, storage and deployment of the system. The pad and support bar carrier may allow for ready visual identification of each pad and support bar. Instructions may be printed on the pads and support bars, and/or separately provided in a manual. The pads and support bars may be provided as part of a knee flexion rehabilitation device system, or as a separate system expansion kit.

A method of using the foregoing knee flexion rehabilitation device may comprise removably mounting a first pad to a support bar, the first pad comprising a first outer diameter; positioning the support bar, having mounted the first pad, at the posterior of a knee joint; moving the knee joint through a first range of motion; removing the support bar from the posterior of the knee joint; removing the first pad from the support bar; removably mounting a second pad to a support bar, the second pad comprising a second outer diameter less than the first outer diameter; positioning the support bar, having mounted the second pad, at the posterior of the knee joint; and moving the knee joint through a second range of motion.

Alternately, a method of using the foregoing knee flexion rehabilitation device may comprise nestably and removably mounting a plurality of pads to a support bar; positioning the support bar, having mounted the plurality of pads, at the posterior of a knee joint; moving the knee joint through a first range of motion; removing the support bar from the posterior of the knee joint; removing the outermost pad of the plurality of pads from the support bar; positioning the support bar, having the outermost pad removed, at the posterior of the knee joint; and moving the knee joint through a second range of motion.

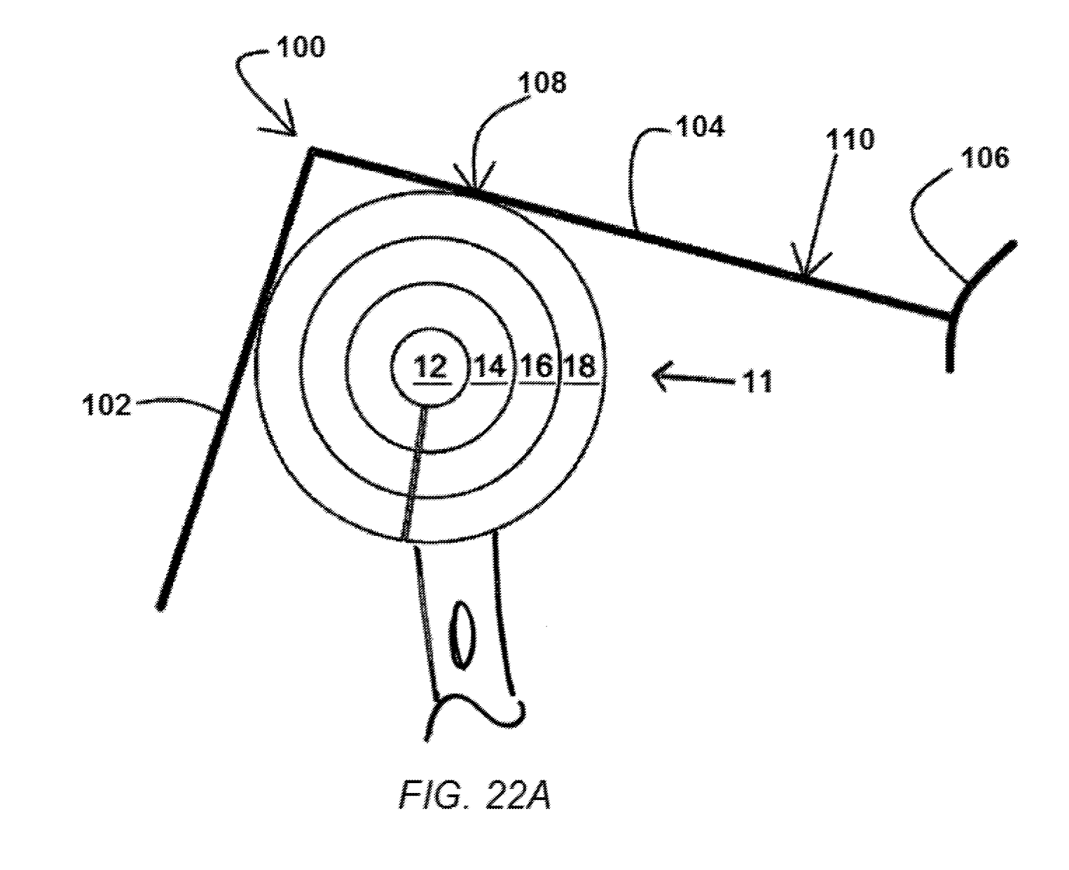

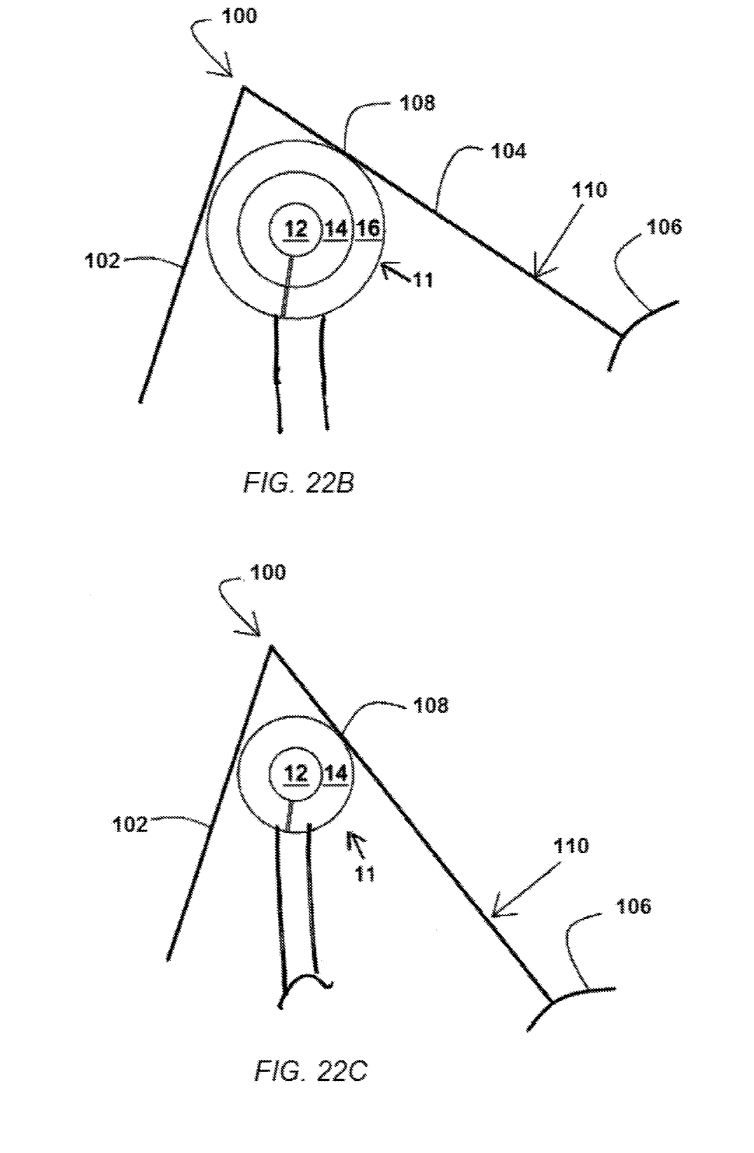

As may be seen in the embodiments, the layers may incrementally increase the diameter of the support bar to allow a physical therapist a method of incrementally increasing a patient's knee flexion. With reference to the embodiment of FIG. 22A-C, a patient may have limited range of motion in a knee 100, which may allow only a relatively large angle between the femur 102 and tibia 104. For such a patient, a plurality of layers may be used to increase the effective diameter of the support bar 12. In the embodiment of FIG. 22A, a first pad layer 14, a second pad layer 16 and a third pad layer 18 may be disposed around the support bar 12, thus providing a larger diameter support. While a patient is supine, for example, the patient's leg may rest over the support bar 12 such that the support bar 12 is disposed substantially under the patient's knee 100. The patient's lower leg, which may include the tibia 104 and foot 106, may extend beyond the support bar 12. The support bar 12 may thus serve as a fulcrum point 108 or area upon which the upper portion of the lower leg may rest and pivot. The larger diameter support bar ensures that the support bar is disposed away from the femur a distance approximating the radius of the support bar, thus establishing the fulcrum point farther away from the knee. So disposed, the physical therapist may move the lower leg through a range of motion to help stretch the knee joint tissues. The lower leg may effectively serve as a lever, with the femur and patient's body weight at the knee side of the fulcrum point serving as an anchor weight, and gravity force and/or the physical therapist's pressure 110 at the foot end of the lower leg serving to distract the knee joint. The fulcrum placement may alter the mechanical advantage of the lever so as to selectively multiply the physical therapist's force or effect of gravity. A larger diameter may allow a physical therapist to treat a knee joint shortly after surgery, for example, and may allow for increased patient comfort even with substantial post-operative swelling. A larger diameter may effectively provide a larger surface area on which the patient's leg may rest, thus spreading the fulcrum pressures and correspondingly reducing patient discomfort.

As the range of motion of the knee 100 increases, the third pad layer 18 may be removed from the support bar 12, thus reducing the effective diameter of the support bar, as may be seen in the embodiment of FIG. 22B. The second pad layer 16 may thus support knee 100 directly. The smaller effective diameter of the second pad layer 16 may allow for a more acute angle between the femur 102 and tibia 104 than the angle allowed by the third pad layer 18. The second pad layer 16 may allow the fulcrum point 108 to be closer to the knee joint, thus changing the mechanical advantage provided by the support bar and further multiplying the force generated by gravity or by physical therapist pressure 110.

As the range of motion of the knee 100 still further increases, the second pad layer 16 may be removed from the support bar 12, thus reducing the effective diameter of the support bar, as may be seen in the embodiment of FIG. 22C. The first pad layer 14 may thus support the knee 100 directly. The smaller effective diameter of the support bar 12 may allow for an even more acute angle between the femur 102 and tibia 104 than the angle allowed by the second pad layer 16. The first pad layer 14 may allow the fulcrum point 108 to be closer to the knee joint, thus changing the mechanical advantage provided by the support bar and yet further multiplying the force generated by gravity or by physical therapist pressure 110. Thus, by changing the effective diameter of the support bar, the physical therapist may effectively control the maximum flexion angle.

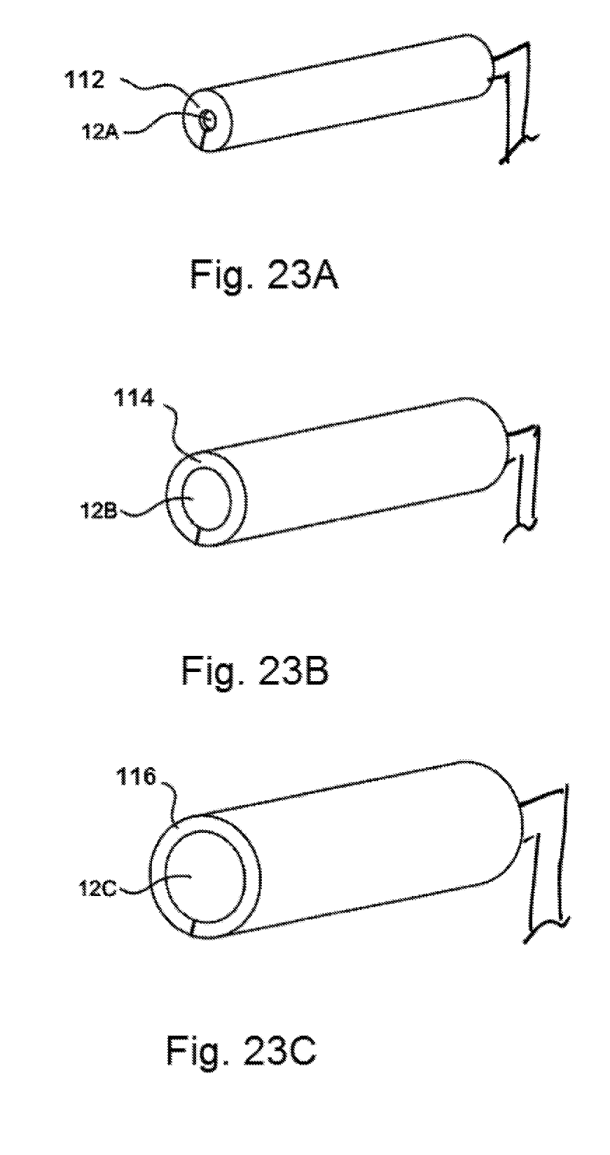

In yet further embodiments, a system of support bars may be provided, wherein each support bar may comprise a different diameter. As may be seen in the embodiment of FIGS. 23A, 23B, and 23C, a plurality of support bars 12A, 12B, and 12C may be provided, with each support bar comprising a different diameter. Support bar 12A may be, for example, 0.5 inches in diameter. Support bar 12B may be, for example, 1.5 inches in diameter. Support bar 12C may be, for example, 2.5 inches in diameter. In some embodiments, each support bar 12A, 12B and 12C may be covered by a pad 112, 114, and 116, respectively. In other embodiments, a support bar may not be covered by a pad. The pads 112, 114, and 116 may be of the same or different thickness, material, color, texture or marking as suitable to provide a desired overall diameter of support bar and pad. For example, each pad 112, 114, and 116 may be 0.5 inches thick, thus rendering the overall diameter for support bars 12A, 12B, and 12C with pads 112, 114, and 116 as 1.5 inches, 2.5 inches and 3.5 inches, respectively. Of course, the number of such support bars is not limited to three, and any number of such support bars may be provided as desired to provide a supported range of knee joint motion. The plurality of support bars may be configured for removable or interchangeable mounting to a knee flexion rehabilitation device 10. In other embodiments, a plurality of knee flexion rehabilitation device 10 or components thereof may be provided, each having a different diameter support bar. In yet further embodiments, each of the plurality of support bars may be configured to receive one or more nested pads, such as the nested pads as described above. Thus, varying support bar diameters and pad arrangements may be used to provide a plurality of overall support diameters suitable for treating a patient's condition.

A system of such support bars may be used progressively as described above to provide various overall support diameters. For example, a support bar 12C with pad 116 may be used initially to support a patient's knee through a first range of motion, then a support bar 12B with pad 114 may be used to support a patient's knee through a second range of motion greater than the first range of motion, and then a support bar 12A with pad 112 may be used to support a patient's knee through a third range of motion greater than the second range of motion.

The disclosed method and apparatus focused on the application of knee rehabilitation, yet the same methods and apparatus could be applied to other joints. Elbows, shoulders, ankles, wrists, and any other joint that may benefit from controlled flexion therapies may be addressed through the disclosed material. For each joint, placement of the device in reference to the joint may require minor modification dependent on the degrees of freedom seen for each particular joint with actual placement determined by which plane and axis of motion a therapy protocol will address for the particular session. In addition to joint placement, the proper diameter pads may vary from joint to joint, so that a complete set of pads for the apparatus may include more than the minimal diameters shown and discussed. For example, an elbow may be better suited for applying the joint to the device from the underside of the support bar and pad, utilizing a set of smaller pads than for a knee, and then flexing upward around the pad rather than downward over the pad.

Although the disclosed subject matter and its advantages have been described in detail, it should be understood that various changes, substitutions and alterations can be made herein without departing from the invention as defined by the appended claims. Moreover, the scope of the claimed subject matter is not intended to be limited to the particular embodiments of the process, machine, manufacture, composition, or matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods or steps.

1-59. (canceled)

60. A knee joint flexion rehabilitation apparatus comprising:
a mounting bracket comprising a base stand configured to be self-supporting and a receiving tube attached to the base stand and extending upward;
a tubular strut configured for mounting to the receiving tube of the mounting bracket;
a support bar fixed substantially perpendicularly to the tubular strut; and
a pad, reversibly connected to the support bar, being configured to receive a knee joint posterior.

61. The apparatus of claim 60, wherein the base stand extends to a point beneath the support bar.

62. The apparatus of claim 60, wherein the base stand further comprises members configured to engage a floor surface and allow for ease of movement across the floor surface.

63. The apparatus of claim 60, wherein the base stand further comprises wheels.

64. The apparatus of claim 60, the tubular strut comprising:
a plurality of first apertures disposed radially therethrough; and
a pin configured for removable disposition in one of the plurality of first apertures so as to fix the strut against translation in one direction with respect to the mounting bracket.

65. A method of using the apparatus of claim 64, the method comprising the steps of:
orienting a patient to an elevated supine position upon a substantially level surface;
raising the patient's leg;
disposing the apparatus under the patient so that the support bar is substantially between the patient's knee and the surface upon which the patient is supine;
translating the tubular strut so that the support bar contacts the posterior knee joint of the patient's leg or approximately thereto; and
allowing the lower portion of the patient's leg to extend past the support bar in cantilever fashion so as to permit a gravitational force on the lower portion to promote rehabilitation of the knee joint.

66. The method of claim 65 further comprising the step of inserting the pin into one of the plurality of second apertures so as to prevent translation of the support bar toward the table.

67. The method of claim 65 further comprising the step of inserting the pin into one of the plurality of first apertures and into the second aperture so as to prevent translation and rotation of the tubular strut and support bar.

68. The method of claim 65 further comprising the steps of:
raising the patient's leg;
removing the pad;
attaching a pad of a different cross sectional dimensions; and
allowing the lower portion of the patient's leg to extend past the support bar in cantilever fashion so as to permit a gravitational force on the lower portion to promote rehabilitation of the knee joint.
